(19) United States
(12) Patent Application Publication
(10) Pub. No.: US 2013/0333173 A1
(43) Pub. Date: Dec. 19, 2013

(54) BLADE ROOT SPRING INSERTION JIG AND INSERTION METHOD OF BLADE ROOT SPRING

(71) Applicant: Mitsubishi Heavy Industries, Ltd., (US)

(72) Inventors: Yasunori Nishioka, Tokyo (JP); Masahito Kataoka, Tokyo (JP); Yoshimasa Takaoka, Tokyo (JP)

(73) Assignee: MITSUBISHI HEAVY INDUSTRIES, LTD., Tokyo (JP)

(21) Appl. No.: 13/847,554

(22) Filed: Mar. 20, 2013

(30) Foreign Application Priority Data
Jun. 15, 2012 (JP) 2012-135427

(51) Int. Cl. F01D 5/30; B25B 27/30

(52) U.S. Cl. CPC F01D 5/30; B25B 27/30
USPC 29/23.51; 29/451

(57) ABSTRACT

A blade root spring insertion jig and a blade root spring insertion method are provided for inserting a blade root spring into a gap between a bottom face of a blade groove formed in a rotor disk of a rotary machine and a blade root part of a blade which engages with the blade groove. The blade root spring has a blade contact face contacting the blade root part and a rotor contact face contacting the bottom face of the blade groove. The blade root spring insertion jig is provided with a first abutment face contacting a blade contact face side of the blade root spring and a second abutment face opposing the first abutment face and contacting a rotor contact face side of the blade root spring, and is configured so that the first abutment face and the second abutment face press the blade root spring so that the blade root spring is compressed to a height smaller than a natural height of the blade root spring.

### TECHNICAL FIELD

The present invention relates to a blade root spring insertion jig and a blade root spring insertion method for inserting a blade of a rotary machine in a blade groove of a rotor disk.

### BACKGROUND ART

A rotary machine such as a steam turbine, a gas turbine and a compressor is normally configured such that blades are installed radially in the rotor disk provided in a rotor which is a rotary member and this rotor is housed in a casing which is a stator member and to which vanes are fixed. In the rotor disk, a plurality of blade grooves are formed in the outer circumference. By engaging the blade root part of the blade in this blade groove, the blade is supported by the rotor disk.

During a rated operation of a rotary machine, a rotor rotates at a high speed and thus, a large centrifugal force acts on a blade. This centrifugal force directed outward in the radial direction acts to press the blade against the blade groove so that the blade is held there. As a result, the blade is prevented from moving or falling with respect to the rotor disk and the blade is held at a prescribed position.

In contrast, during a low-speed rotation of the rotary machine, such as start up or turning of the rotary machine, a centrifugal force acting on the blade is not so high and thus, the blade is caused to rattle due to the effects of the gravity resulting from the self-weight and its moment. This causes abrasion or deformation of the blade root part of the blade or blade groove. At the same time, the center of the gravity of the blade changes and this leads to axial vibration and the abrasion or deformation of the parts progresses. As a result, the blade is held at a position off from the prescribed position even during the rated operation and this may cause the axial vibration.

As an improvement made in view of the above issues, a structure is known in which a blade root spring is interposed between the blade root part of the blade and the blade groove. The blade root spring is configured to press the blade outward in the radial direction of the blade groove so that the blade root part is brought into close contact with the blade groove and the blade is held there.

When attaching the blade to the blade groove of the rotor disk, first the blade root part of the blade is inserted in the blade groove and then the blade groove spring is hammered in a gap between the blade root part and the blade groove. It is described in Patent Literature 1 that a front end portion of the blade root spring tapers in an insertion direction to make it easier to hammer the blade root spring into the blade groove (see FIG. 12, Patent Literature 1).

### CITATION LIST

### Patent Literature

[PTL 1]

JP 2005-273646 A

### SUMMARY

### Technical Problem

As described in Patent Literature 1, in the case of hammering the blade root spring into the blade groove using the taper shape of the blade spring, the blade root spring deforms (compresses) during insertion of the blade root spring into the blade groove by an amount corresponding to the height of the taper shape at most. The elastic force resulting from the deformation amount of the blade root spring acts on the blade root part of the blade, pressing the blade root part against the blade groove. However, there is a limit to the height of the taper shape that can be formed in the blade root spring. Thus, to achieve a large pressing force, it is necessary to increase the spring constant of the blade root spring.

Herein, the blade root spring having a high spring constant has a high rate of change of an elastic force with respect to the deformation amount (compression amount). Therefore, the elastic force of the blade root spring having a high spring constant is easily affected by manufacturing tolerance of the blade root part of the blade, the blade groove or the blade root spring and dispersion of the force of pressing the blade root part to the blade groove tends to occur. Therefore, a blade root spring having a higher spring constant is used to be on the safe side, so as to achieve a desired pressing force even when the deformation amount (compression amount) of the blade root spring is smaller than a design value due to the manufacturing tolerance.

Thus, according to the method described in Patent Literature 1, the blade root spring having a sufficiently high spring constant must be used with consideration of influence of the manufacturing tolerance. In this case, a large force must be applied to insert the blade root spring in the blade groove and the blade root spring is hit hard with a hammer or forced into the groove using a hydraulic jack. Thus, it is difficult to insert the blade root spring in the blade groove effectively. Further, by hitting the blade root spring hard with a hammer, the blade root spring is prone to get damaged.

It is an object of at least some embodiments of the present invention to provide a blade root spring insertion jig and a blade root spring insertion method which make it possible to effectively perform insertion of the blade root spring in a blade groove.

### Solution to Problem

According to one embodiment of the present invention, a blade root spring insertion jig for inserting a blade root spring into a gap between a bottom face of a blade groove formed in a rotor disk of a rotary machine and a blade root part of a blade which engages with the blade groove, the blade root spring having a blade contact face contacting the blade root part and a rotor contact face contacting the bottom face of the blade groove, comprises:
a first abutment face contacting a blade contact face side of the blade root spring; and
a second abutment face opposing the first abutment face and contacting a rotor contact face side of the blade root spring,
wherein the first abutment face and the second abutment face are configured to press the blade root spring so that the blade root spring is compressed and a height of the blade root spring becomes smaller than a natural height of the blade root spring.

Herein, the height of the blade root spring refers to a distance between the blade contact face and the rotor contact face of the blade root spring, and the natural height of the blade root spring refers to a height of the blade root spring when the load is not applied to the blade root spring.

With the above-described insertion jig, the blade root spring can be compressed in advance by pressing the blade root spring by the first abutment face and the second abutment face of the insertion jig. Thus, the blade root spring can be inserted easily in the gap between the blade root part of the blade and the blade groove.

Further, compared to the case where the blade root spring is hammered into the blade groove using the taper shape of the blade root spring alone, it is possible to increase a deformation amount (a compression amount) of the blade root spring. Thus, a blade root spring of relatively small spring constant can be used. Normally when manufacturing the blade root spring, even in the case of a product having the minimum deformation amount that possibly occurs due to influence of manufacturing tolerance, a target value of the pressing load for achieving a required pressing load is set (a safety factor may be taken into account). Herein, the blade root spring with a high spring constant has a high rate of change of an elastic force relative to the deformation amount (the compression amount) and is more likely to be affected by the manufacturing tolerance than the blade root spring with a small spring constant. Thus, the target value of the pressing load is set higher for the blade root spring with a high spring constant than the blade root spring with a small spring constant. Therefore, by comparing pressing forces of the product with the maximum deformation amount of the blade root spring that possibly occurs due to influence of the manufacturing tolerance, the pressing force of the blade root spring with a high spring constant is much higher than that of the blade root spring with a small spring constant. By using the blade root spring with a high spring constant, a larger force is needed to insert the blade root spring into the gap between the blade root part and the blade groove depending on a product. In contrast, the blade root spring with a small spring constant is less likely to be affected by the manufacturing tolerance as the change rate of the elastic force relative to the deformation amount (the compression amount) is small. Therefore, for the product having the smallest deformation amount of the blade root spring that possibly occurs due to influence of the manufacturing tolerance, the target value of the pressing load for achieving the required pressing load is set smaller than that of the blade root spring with a high spring constant. Therefore, the pressing force of the product having the maximum deformation amount of the blade root spring that possibly occurs due to influence of the manufacturing tolerance is significantly smaller than the pressing force of the case where the spring constant is high. Thus, by using the blade root spring with a small spring constant, it no longer needs a large force to insert the blade root spring into the gap between the blade root part and the blade groove and the blade root spring can be inserted into the gap easily.

In some embodiments, the blade root spring insertion jig further comprises:
a first member comprising the first abutment face;
a second member comprising the second abutment face; and
a clearance adjustment mechanism for changing a distance between the first member and the second member to adjust a clearance between the first abutment face and the second abutment face.

In this case, by changing the distance between the first member and the second member in such a state that the blade root spring is pressed between the first member and the second member, the clearance between the first abutment face and the second abutment face can be easily adjusted. Thus, it is possible to adjust the compression amount of the blade root spring appropriately and it is also possible to effectively perform insertion of the blade root spring using the blade root spring insertion jig.

In one embodiment, the blade root spring insertion jig may be configured so that a projection is formed on the first member to contact the blade contact face.

As a result, it becomes easier to insert the blade root spring in the blade groove as the blade contact face of the blade root spring is depressed by abutting, when compressing the blade root spring using the blade root spring insertion jig, the projection of the first member to the blade contact face of the blade root spring which will contact the blade root part.

In some embodiments, at least one of the first abutment face or the second abutment face may have a taper shape such that a distance between the first abutment face and the second abutment face gradually becomes smaller along an insertion direction of the blade root spring.

In this case, while the blade root spring is moved in the blade root spring insertion jig along the insertion direction of the blade root spring to pass through between the first abutment face and the second abutment face, the blade root spring is compressed by being pressed by the first abutment face and the second abutment face. Further, by setting the shape of at least one of the first abutment face or the second abutment face to be a taper shape, the compression amount of the blade root spring which is defined according to reduction in the height of the clearance between the first abutment face and the second abutment face can be appropriately adjusted. Furthermore, as at least one of the first abutment face or the second abutment face has a taper shape such that a distance between the first abutment face and the second abutment face gradually becomes smaller, the blade root spring can be smoothly inserted in the gap between the blade root part of the blade and the blade groove.

In one embodiment, the blade root spring insertion jig may further comprise a pair of sidewall faces which forms with the first abutment face and the second abutment face a space for housing the blade root spring, and the pair of sidewall faces may be inclined relative to a jig end face of the blade root spring insertion jig so that the pair of sidewall faces is parallel to the blade groove when the jig end face is abutted to a disk end face of the rotor disk in a periphery of the blade groove.

As the blade root spring insertion jig has the pair of sidewall faces that is parallel to the blade groove when the jig end face is abutted to the disk end face of the rotor disk, by abutting to the disk end face of the rotor disk the end face of the insertion jig in which the blade root spring is installed, and then pressing the rear end of the blade root spring, the blade root spring is guided appropriately by the sidewall faces into the gap between the blade groove and the blade root part and the blade root spring can be smoothly inserted in the gap.

In another embodiment, a clearance between the first abutment face and the second abutment face may be set so that the height of the blade root spring compressed by the first abutment face and the second abutment face is greater than the gap between the bottom face of the blade groove and the blade root part.

If the blade root spring can be used beyond its elasticity limit, even when the spring constant is the same, a larger pressing force can be obtained. However, when the blade root spring is deformed beyond the elasticity limit and then the compression force acting on the blade root spring is released, plastic deformation of the blade root spring occurs, making it impossible to fulfill original functions of the blade root spring. Therefore, in order to use the blade root spring in the region beyond its elasticity limit, it is necessary that the deformation amount (compression amount) is maximum in such a state that the blade root spring is inserted in the gap between the bottom face of the blade groove and the blade root part. In view of this, the clearance between the first abutment face and the second abutment face, which defines the compression amount of the blade root spring within the insertion jig, is set in such a range that the height of the blade root spring after being compressed by the first abutment face and the second abutment face does not become smaller than a height of the gap between the bottom face of the blade groove and the blade root part. As a result, it is possible to use the blade root spring in the range beyond the elasticity limit.

In yet another embodiment, the blade root spring insertion jig may further comprise a roller provided in an abutment part of at least one of the first member or the second member, the abutment part being configured to contact the blade root spring.

By providing the roller in the abutment part of at least one of the first member or the second member where the abutment part contacts the blade root spring, it is possible to reduce friction that occurs between the blade root spring and the blade root spring insertion jig when inserting the blade root spring in the gap between the blade groove and the blade root part, and it is also possible to smoothly insert the blade root spring in the gap.

In one embodiment, a blade root spring insertion method for inserting a blade root spring into a gap between a bottom face of a blade groove formed in a rotor disk of a rotary machine and a blade root part of a blade which engages with the blade groove, comprises steps of;
compressing the blade root spring so that a height of the blade root spring becomes smaller than a natural height of the blade root spring; and
inserting the blade root spring in the blade groove in such a state that the blade root spring is compressed.

According to the above blade root spring insertion method, the blade root spring is inserted in the blade groove in such a state that the blade root spring is already compressed so that the height of the blade root spring is smaller than its natural height. This makes it easy to insert the blade root spring in the blade groove.

Further, compared to the case where the blade root spring is hammered into the blade groove using the taper shape of the blade root spring alone, it is possible to increase a deformation amount (a compression amount) of the blade root spring. Thus, a blade root spring of relatively small spring constant can be used. The blade root spring with a small spring constant has a small rate of change of an elastic force relative to the deformation amount (the compression amount) compared to the blade root spring with a high spring constant. Thus, the blade root spring with a small spring constant is less likely to be affected by the manufacturing tolerance and dispersion of the force of pressing the blade root part to the blade groove is unlikely to occur. Therefore, even in the case where the deformation amount (the compression amount) of the blade root spring due to influence of the manufacturing tolerance is smaller than the design value, relatively low spring constant of the blade root spring suffices for obtaining the desired pressing force. This makes it even easier to insert the blade root spring in the gap between the blade root part of the blade and the blade groove.

### Advantageous Effects

According to at least one embodiment of the present invention, it is possible to insert the blade root spring easily in the gap between the blade root part of the blade and the blade groove by compressing the blade root spring beforehand.

### BRIEF DESCRIPTION OF DRAWINGS

FIG. 1 is a perspective illustration of a blade root spring inserted in a gap between a blade and a rotor disk.

FIG. 2 is a perspective illustration of the blade root spring.

FIG. 3 is a perspective illustration of a blade root spring insertion jig.

FIG. 4 is a cross-sectional view of the blade root spring insertion jig along line A-A of FIG. 3.

FIG. 5 is a fragmentary view of a spring housing body taken in the direction of arrow B of FIG. 4.

FIG. 6 is a fragmentary view of a cover body taken in the direction of arrow C of FIG. 4.

FIG. 7 is an explanatory illustration of a blade root spring insertion method.

FIG. 8 is a cross-sectional view of a blade root spring insertion jig having a jig taper portion.

FIG. 9 is a cross-sectional view of a blade root spring insertion jig applied to a blade root spring having a spring taper portion.

FIG. 10A is a cross-sectional view of a blade root spring insertion jig having rollers.

FIG. 10B is a plan view of a spring housing body of the blade root spring insertion jig having the rollers.

FIG. 11 is a graph illustrating a relationship between a product frequency and a pressing load of each of two blade root springs having different spring constants.

### DETAILED DESCRIPTION

Embodiments of the present invention will now be described in detail with reference to the accompanying drawings. It is intended, however, that unless particularly specified in these embodiments, dimensions, materials, and shapes of components and their relative positions and the like shall be interpreted as illustrative only and not limitative of the scope of the present invention.

In the following embodiments, explained as one example is the case where a blade root spring insertion jig and an insertion method according to the following embodiments are applied to a turbine unit of a gas turbine which is a rotary machine. However, the present invention is also applicable to other types of rotary machines such as an air compressor of a gas turbine, a steam turbine and a jet engine.

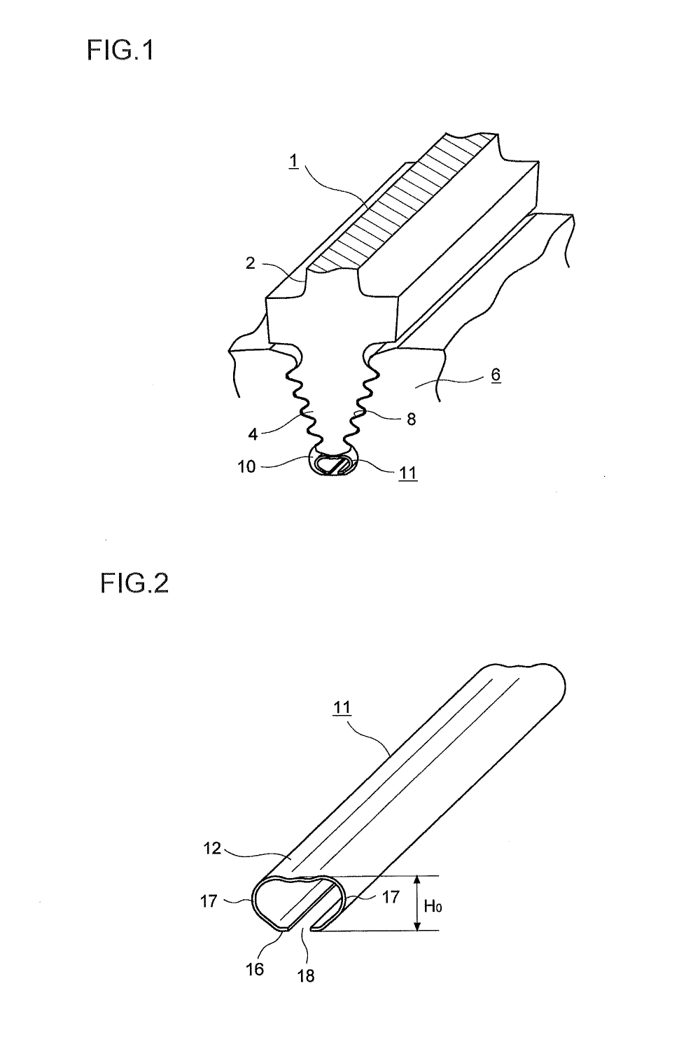

First, the case where a blade 1, a rotor disk 6 and a blade root spring 11 are used is described. FIG. 1 is a perspective illustration of the blade root spring inserted in a gap between the blade and the rotor disk. FIG. 2 is a perspective illustration of the blade root spring.

As illustrated in FIG. 1, the blade 1 which is a turbine blade includes a blade part 2 forming a blade surface, and a blade root part 4 provided at one end of the blade part 2 on the rotor disk side. The rotor disk 6 includes a blade groove 8 which has a shape corresponding to the blade root part 4. This blade groove 8 extends along an axial direction of a rotor. The blade 1 is supported by the rotor disk 6 by engaging the blade root part 4 to the blade groove 8. In such a state that the blade root part 4 is engaged to the blade groove 8, a gap 10 is formed between the blade root part 4 and the blade groove 8. In this gap 10, a blade root spring 11 is inserted. The blade root spring 11 functions to push the blade 1 outward in the radial direction with respect to the rotor disk 6.

As illustrated in FIG. 2, the blade root spring 11 may be a long plate spring which includes a blade contact face 12 contacting the blade root part 4 and a rotor contact face 16 contacting the blade groove 8. For instance, the blade root spring 11 may be configured by integrally forming: a pair of the rotor contact faces 16 disposed across an opening 18 from each other; and the blade contact face 12 disposed approximately parallel to the pair of rotor contact faces 16 via a pair of side faces 17 having a curved shape. Further, the blade contact face 12 may also have a curved shape. FIG. 2 illustrates the case where the blade contact face 12 is formed with three curved portions to fit along the shape of the end of the blade root part 4.

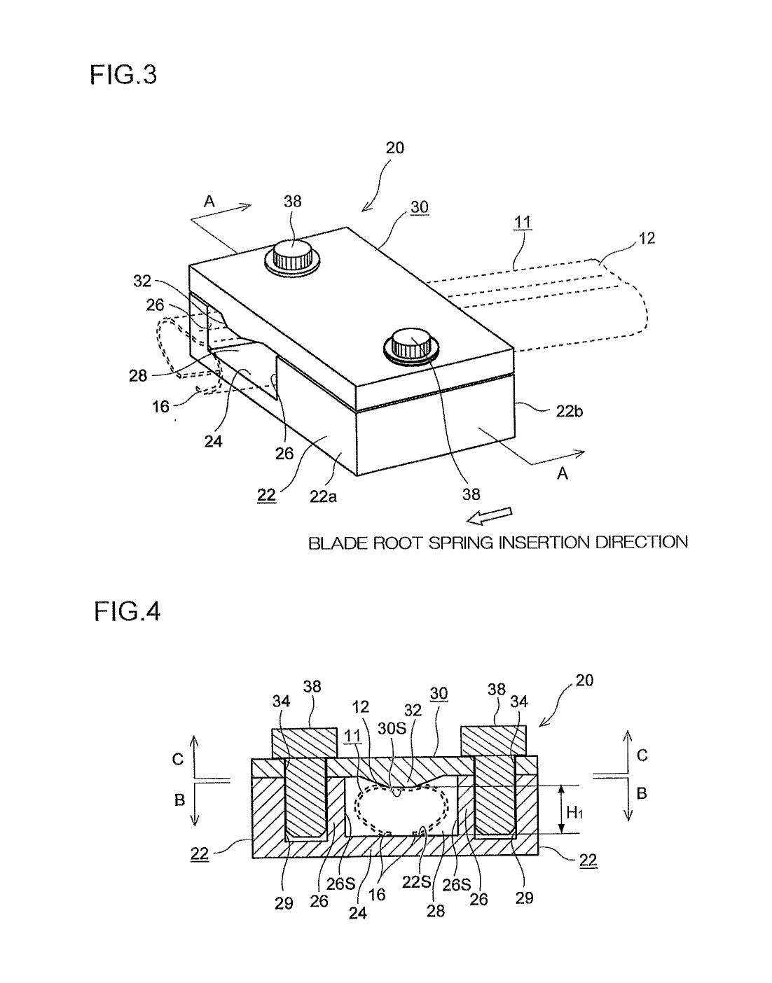

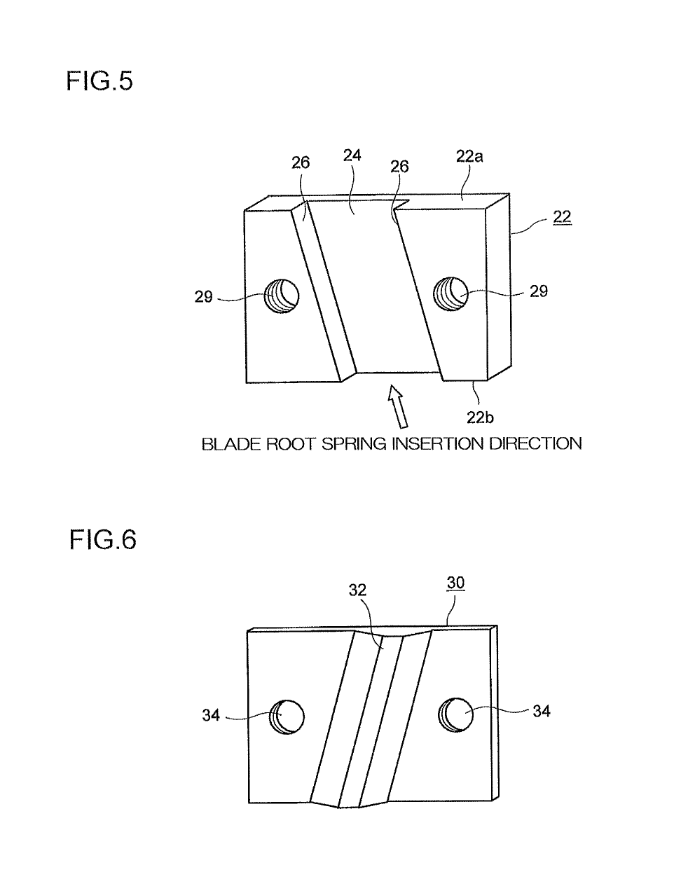

In reference to FIG. 3 to FIG. 6, a blade root spring insertion jig 20 according to this embodiment is explained in detail. Herein, FIG. 3 is a perspective illustration of the blade root spring insertion jig. FIG. 4 is a cross-sectional view of the blade root spring insertion jig along line A-A of FIG. 3. FIG. 5 is a fragmentary view of a spring housing body taken in the direction of arrow B of FIG. 4. FIG. 6 is a fragmentary view of a cover body taken in the direction of arrow C of FIG. 4. In FIG. 3 and FIG. 4, the blade root spring 11 is illustrated with a broken line.

As illustrated in FIG. 3 and FIG. 4, the blade root spring insertion jig 20 includes a cover body (a first member) 30 having a first abutment face 30S, and a spring housing body (a second member) 22 having a second abutment face 22S opposing the first abutment face 30S. The first abutment face 30S of the cover body 30 is configured to contact the blade contact face 12 of the blade root spring 11 when installing the blade root spring 11 into the blade root spring insertion jig 20. In contrast, the second abutment face 22S of the spring housing body 22 is configured to contact the rotor contact face 16 of the blade root spring 11 when installing the blade root spring 11 into the blade root spring insertion jig 20.

A deformation amount (a compression amount) of the blade root spring 11 caused by the blade root spring insertion jig 20 is defined by a clearance H₁ between the first abutment face 30S and the second abutment face 22S. In some embodiments, the blade root spring insertion jig 20 is provided with a clearance adjustment mechanism for adjusting the clearance H₁ between the first abutment face 30S and the second abutment face 22S. The clearance adjustment mechanism is described later in details.

In one embodiment, the spring housing body 22 includes a bottom part 24 forming the second abutment face 22S and a pair of sidewall parts 26, 26 which are disposed almost vertical to the bottom part 24 and which face each other. The pair of sidewall parts 26, 26 includes a pair of sidewall faces 26S, 26S. The pair of sidewall faces 26S, 26S forms with the first abutment face 30S and the second abutment face 22S a space 28 for housing the blade root spring 11. When the cover body 30 is attached to the spring housing body 22, the space 28 opens to end faces 22a, 22b of the spring housing body 22 on both sides (on both end sides in an insertion direction of the blade root spring). Further, the blade root spring insertion jig 20 may be configured so that the length of the space 28 in the insertion direction is shorter than the length of the blade root spring 11 in the longitudinal direction. In this case, it is possible to push the blade root spring 11 toward the rotor disk 6 side by hammering a rear end of the blade root spring 11 projecting from the blade root spring insertion jig 20. This facilitates insertion of the blade root spring 11. As illustrated in FIG. 4 and FIG. 5, at least one bolt hole 29, 29 may be provided on each side of the spring housing body 22 (the sidewall parts 26, 26) with the space 28 therebetween. Further, in the case where the blade groove 8 is inclined relative to the direction perpendicular to the end face of the rotor disk 6, the pair of sidewall faces 26S, 26S may be inclined relative to the end face 22a so that the pair of sidewall faces 26S, 26S is parallel to the blade groove 8 when one end face 22a of the spring housing body 22 is abutted to the end face of the rotor disk 6. As a result, the blade root spring 11 is appropriately guided by the side faces 26S, 26S into the gap 10 between the blade groove 8 and the blade root part 4 when housing the blade root spring 11 in the blade root spring insertion jig 20 and inserting the blade root spring 11 into the gap 10.

As illustrated in FIG. 3, FIG. 4 and FIG. 6, the cover body (the first member) 30 includes the first abutment face 30S and is arranged to cover a top face of the spring housing body (the second member) 22. In the cover body 30, bolt holes 34 may be provided corresponding to the bolt holes 29, 29 of the spring housing body 22. Further, in the cover body 30, a projection 32 extending in the insertion direction of the blade root spring 11 may be provided in an abutment part of the cover body 30 where the cover body 30 contacts the blade root spring 11. In this case, the projection 32 may form at least a part of the first abutment face 30S. Further, in a later-described configuration, the case where the projection 32 is provided is explained in details. However, this is not limitative and the cover body 30 may be formed without the projection 32. As described above, in the case where the sidewall faces 26S, 26S of the spring housing body 22 are inclined relative to the end face 22a, the longitudinal direction of the projection 32 is also inclined relative to the end face 22a to be parallel to the sidewall faces 26S, 26S.

In reference to FIG. 4, the clearance adjustment mechanism is configured to adjust the clearance H₁ between the first abutment face 30S of the cover body 30 and the second abutment face 22S of the spring housing body 22 to be smaller than a natural height H₀ of the blade root spring 11. Herein, as illustrated in FIG. 1, the height of the blade root spring 11 refers to a distance between the blade contact face 12 and the rotor contact face 16 of the blade root spring 11, and the natural height H₀ of the blade root spring 11 refers to a height of the blade root spring 11 when the load is not applied to the blade root spring 11. In the example illustrated in FIG. 4, the clearance adjustment mechanism includes bolts 38 which are inserted in the bolt holes 34, 34 of the cover body 30, the bolt holes 29, 29 of the spring housing body 22. In such a state that the cover body 30 is abutted to the spring housing body 22, the cover body 30 is fastened to the spring housing body 22 by tightening the bolts 38, the clearance H₁ between the first abutment face 30S of the cover body 30 and the second abutment face 22S of the spring housing body 22 becomes smaller than the natural height H₀ of the blade root spring 11. Further, it is easy to insert the blade root spring 11 compressed between the projection 32 of the cover body 30 and the bottom part 24 of the spring housing body 22 into the gap 10 between the blade root part 4 and the blade groove 8. Thus, the clearance H₁ may be set corresponding to the gap 10 between the blade root part 4 and the blade groove 8.

As described above, the blade root spring insertion jig 20 is configured so that the blade root spring 11 is compressed to a height smaller than its natural height H₀ when being compressed by the first abutment face 30S and the second abutment face 22S. This makes it possible to compress the blade root spring 11 in advance and the insertion of the blade root spring 11 is made easier.

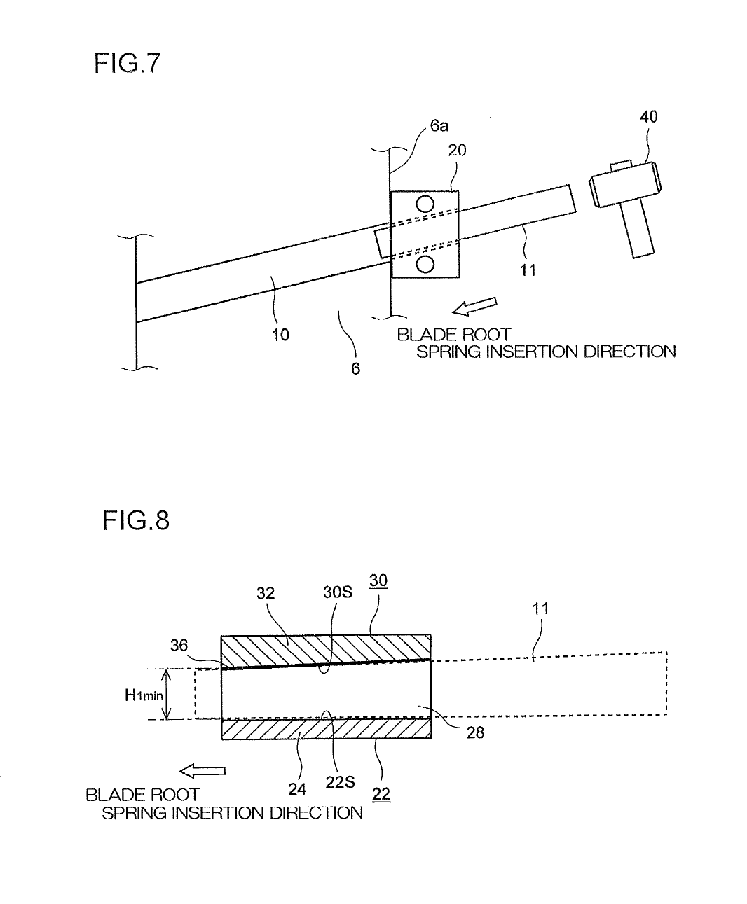

One example of the blade root spring insertion method according to this embodiment is now explained. FIG. 7 is an explanatory illustration of the blade root spring insertion method.

First, in such a state that the blade root spring 11 is housed in the space 28 of the spring housing body 22, the cover body 30 is placed on the blade root spring 11 and then the bolts 38 are inserted in the bolt holes 34, 29 and then tightened to fix the cover body 30 to the spring housing body 22. In this process, the blade root spring 11 is maintained in the state where it is compressed to a height smaller than its natural height H₀, i.e. in the state where the blade root spring 11 is compressed to the height of the clearance H₁ between the first abutment face 30S of the cover body 30 and the second abutment face 22S of the spring housing body 22 and has the elastic force inside.

Then, as illustrated in FIG. 7, the end face 22a of the blade root spring insertion jig 20 is abutted to the end face 6a of the rotor disk 6 and the rear end of the blade root spring 11 projecting from the insertion jig 20 is hit with a hammer 40. In this manner, the blade root spring 11 is inserted into the gap 10 between the blade root part 4 and the blade groove 8. In this process, once the blade root spring 11 is halfway inserted in the gap 10, the blade root spring insertion jig 20 may be removed and the rear end of the blade root spring may be hit with the hammer 40 till the rear end of the blade root spring 11 is inserted in the gap 10.

According to this embodiment, the blade root spring 11 compressed between the projection 32 of the cover body 30 and the bottom part 24 of the spring housing body 22 is inserted into the gap 10 between the blade root part 4 and the blade groove 8. Thus, it is possible to insert the blade root spring 11 easily.

Further, compared to the case where the blade root spring 11 is hammered into the blade groove 8 using the taper shape of the blade root spring 11 alone, it is possible to increase the deformation amount (the compression amount) of the blade root spring 11. Thus, a blade root spring 11 of relatively low spring constant can be used and it becomes even easier to insert the blade root spring 11 into the gap 10 between the blade root part 4 of the blade 1 and the blade groove 8.

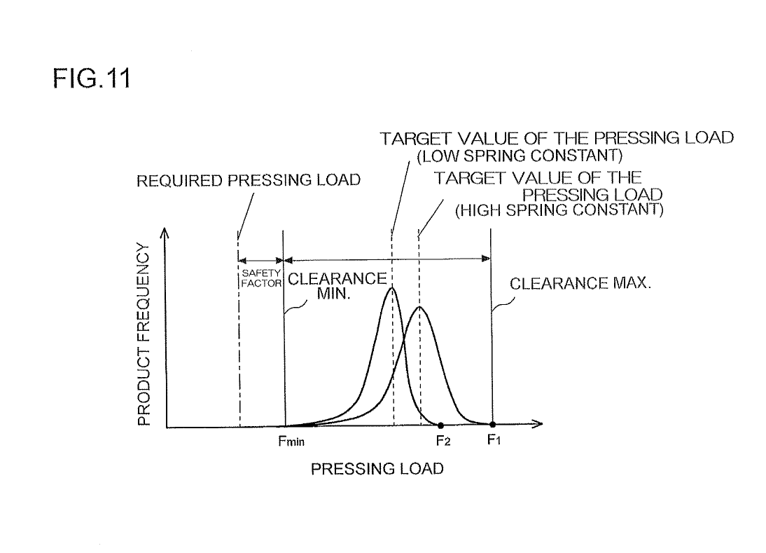

In reference to FIG. 11, explained is why the blade root spring 11 of lower spring constant is easier to insert. FIG. 11 is a graph illustrating a relationship between a product frequency and a pressing load of each of two blade root springs 11 which have different spring constants. As illustrated in the graph, normally when manufacturing the blade root spring 11, even in the case of a product having the minimum deformation amount of the blade root spring that possibly occurs due to manufacturing tolerance (a product with the largest gap 10), a target value of the pressing load for achieving a required pressing load Fₘᵢₙ is set with a safety factor taken into account. Herein, the blade root spring 11 with a high spring constant has a higher rate of change of an elastic force relative to the deformation amount (the compression amount) than the blade root spring 11 with a low spring constant. The elastic force of the blade root spring 11 with a high spring constant is easily affected by manufacturing tolerance. Thus, the target value of the pressing load is set higher for the blade root spring 11 with a high spring constant than the blade root spring 11 with a low spring constant. Therefore, by comparing pressing forces F₁, F₂ of the product with the maximum rate of change that possibly occurs due to the manufacturing tolerance (a product with the smallest gap 10), the pressing force of the blade root spring 11 with a high spring constant is much higher than that of the blade root spring 11 with a low spring constant. By using the blade root spring 11 with a high spring constant, depending on a product, a larger force is needed to insert the blade root spring 11 into the gap 10. In contrast, by using the blade root spring 11 with a low spring constant, it is less likely to be affected by the manufacturing tolerance as the change rate of the elastic force relative to the deformation amount (the compression amount) is small. Therefore, for the product having the smallest deformation amount of the blade root spring that possibly occurs due to influence of the manufacturing tolerance (the product with the largest gap 10), the target value of the pressing load for achieving the required pressing load Fₘᵢₙ with the safety factor taken into account is set smaller than that of the blade root spring with a high spring constant. Therefore, the pressing force F₂ of the product having the maximum deformation amount of the blade root spring 11 that possibly occurs due to influence of the manufacturing tolerance is significantly smaller than the pressing force F₁ of the case where the spring constant is high. Thus, by using the blade root spring 11 with a low spring constant, it no longer needs a large force to insert the blade root spring 11 into the gap 10 between the blade root part 4 and the blade groove 8 and the blade root spring 11 can be inserted into the gap 10 easily.

In some embodiments, at least one of the first abutment face 30S or the second abutment face 22S has a taper shape such that the clearance H₁ between the first abutment face 30S and the second abutment face 22S gradually becomes smaller along the insertion direction of the blade root spring 11. FIG. 8 is a cross-sectional view of a blade root spring insertion jig having a jig taper portion. In this exemplary embodiment illustrated in FIG. 8, the blade root spring insertion jig 20 is provided with a jig taper portion 36 in a region including the first abutment face 30S of the cover body 30 where the first abutment face 30S contacts the blade contact face 12 of the blade root spring 11.

In this case, while the blade root spring 11 is moved in the blade root spring insertion jig 20 along the insertion direction of the blade root spring 11 to pass through between the first abutment face 30S and the second abutment face 22S (in the space 28), the blade root spring 11 is compressed by being pressed by the first abutment face 30S and the second abutment face 22S. The compression amount of the blade root spring 11 while being passed through the space 28 is defined according to reduction in height of the clearance H₁ between the first abutment face 30S and the second abutment face 22S and the final height of the blade root spring 11 is determined by the smallest clearance H₁ₘᵢₙ between the first abutment face 30S and the second abutment face 22S in the region where the jig taper portion 36 is provided. In this manner, by passing the blade root spring 11 through the region where the jig taper portion 36 is provided, the height of the blade root spring 11 becomes smaller than the natural height H₀ of the blade root spring 11. Thus, it is possible to compress the blade root spring 11 in advance and it becomes easier to insert the blade root spring 11.

Further, as at least one of the first abutment face 30S or the second abutment face 22S has a taper shape such that the clearance H₁ between the first abutment face 30S and the second abutment face 22S gradually becomes smaller, the blade root spring 11 can be passed smoothly between the first abutment face 30S and the second abutment face 22S and the insertion of the blade root spring 11 becomes easier.

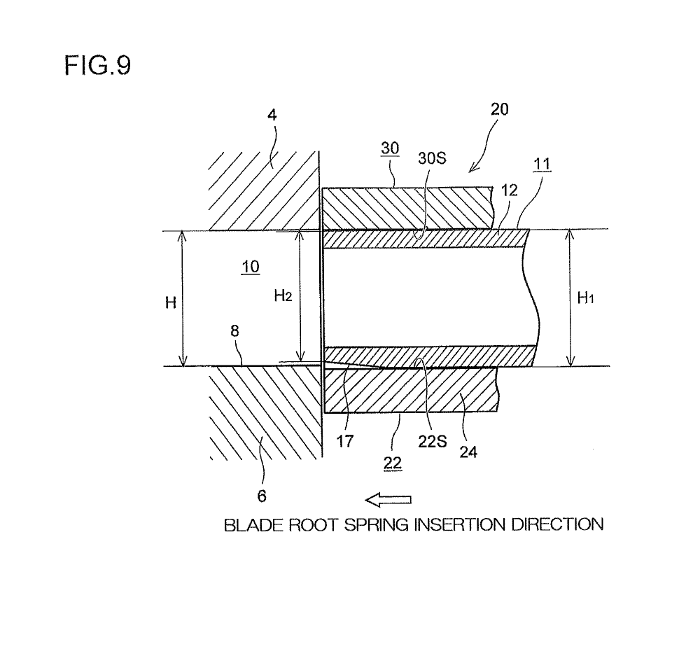

Furthermore, in one embodiment, as illustrated in FIG. 9, the clearance H₁ between the first abutment face 30S and the second abutment face 22S may be set so that the height of the blade root spring 11 compressed by the first abutment face 30S and the second abutment face 22S (≈H₁) is greater than the clearance H of the gap 10 between the bottom face of the blade groove 8 and the blade root part 4 (i.e. H₁>H). In this case, the blade root spring 11 may be configured so that the blade root spring 11 can be used beyond its elasticity limit when being inserted in the gap 10 between the blade root part 4 and the blade groove 8. FIG. 9 is a cross-sectional view of the blade root spring insertion jig applied to the blade root spring having a spring taper portion.

If the blade root spring 11 can be used beyond its elasticity limit, even when the spring constant is the same, a larger pressing force can be obtained. However, when the blade root spring 11 is deformed beyond the elasticity limit and then the compression force acting on the blade root spring 11 is released, plastic deformation of the blade root spring 11 occurs, making it impossible to fulfill original functions of the blade root spring 11. Therefore, in order to use the blade root spring 11 in the region beyond its elasticity limit, it is necessary that the deformation amount (the compression amount) is maximum in such a state that the blade root spring 11 is inserted in the gap 10 between the bottom face of the blade groove 8 and the blade root part 4. In view of this, when using the blade root spring insertion jig 20, the clearance between the first abutment face 30S of the cover body 30 and the second abutment face 22S of the spring housing body 22 is adjusted by means of, for instance, the clearance adjustment mechanism and the jig taper portion 36 within a range greater than the gap 10 between the bottom face of the blade groove 8 and the blade root part 4 (i.e. the range of H₁>H). As a result, it is possible to use the blade root spring 11 in the region beyond its elasticity limit.

In this case, by setting the clearance H₁ between the first abutment face 30S of the cover body 30 and the second abutment face 22S of the spring housing body 22 in the range greater than the clearance H of the gap 10 between the bottom face of the blade groove 8 and the blade root part 4, there is a possibility that it is difficult to insert the blade root spring 11 in the gap 10. Thus, in the example illustrated in FIG. 9, a spring taper portion 17 tapering in the insertion direction of the blade root spring 11 may be provided in the end part of the blade root spring 11 on the rotor disk side. Further, the minimum height H₂ of the blade root spring 11 in the spring taper portion 17 is not greater than the clearance H of the gap 10 between the bottom face of the blade groove 8 and the blade root part 4.

In this manner, when using the blade root spring insertion jig 20, the gap H₁ between the first abutment face 30S of the cover body 30 and the second abutment face 22S of the spring housing body 22 is adjusted in the range greater than the clearance H of the gap 10 between the bottom face of the blade groove 8 and the blade root part 4. Thus, it is possible to use the blade root spring 11 in the range of plastic deformation.

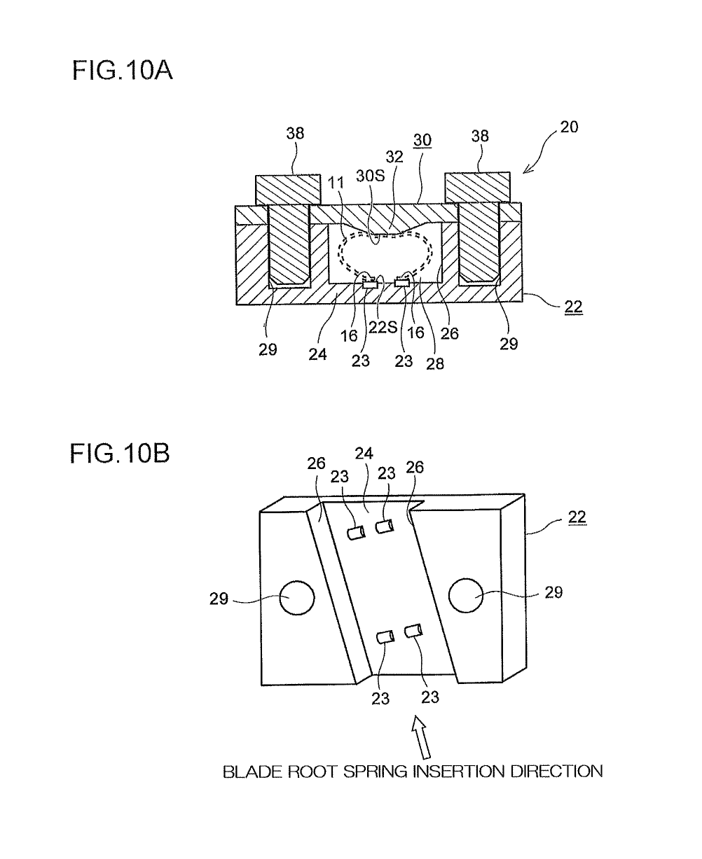

As illustrated in FIG. 10A and FIG. 10B, a roller 23 may be provided in an abutment part of at least one of the cover body (the first member) 30 or the bottom part 24 of the spring housing body (the second member) 22, the abutment part being configured to contact the blade root spring 11. FIG. 10A is a cross-sectional view of the blade root spring insertion jig having rollers. FIG. 10B is a plan view of the spring housing body of the blade root spring insertion jig having the rollers.

In FIG. 10A and FIG. 10B, a plurality of the rollers 23 is provided in the bottom part 24 of the spring housing body 22. These rollers 23 are arranged so that the rotation direction of the rollers 23 coincides with the insertion direction of the blade root spring 11.

By providing the rollers 23 in the part of the blade root spring insertion jig 20, which comes in contact with the blade root spring 11, it is possible to reduce friction that occurs between the blade root spring 11 and the blade root spring insertion jig 20 when inserting the blade root spring 11 in the gap 10 between the blade groove 8 and the blade root part 4, and it is also possible to smoothly insert the blade root spring 11 in the gap 10.

While the embodiments of the present invention have been described, it is obvious that various modifications and changes may be made without departing from the scope of the invention.

In the case illustrated in FIG. 4, the first abutment face 30S has the projection 32 whereas the second abutment face 22S and the sidewall faces 26S, 26S have flat surfaces. However, this is not limitative and the first abutment face 30S, the second abutment face 22S and the sidewall faces 26S, 26S which form the space 28 for housing the blade root spring 11 may have arbitrary shapes.

For instance, the first abutment face 30S, the second abutment face 22S and the sidewall faces 26S, 26S may be shaped corresponding to the shape of the blade root spring 11, such as a flat surface, a curved surface, or may have a projection or a depression on a flat surface or a curved surface.

### REFERENCE SIGNS LIST

1 Blade

2 Blade part

4 Blade root part

6 Rotor disk

6a Rotor disk end face

8 Blade groove

10 Gap

11 Blade root spring

12 Blade contact face

16 Rotor contact face

17 Spring taper portion

18 Opening

20 Blade root spring insertion jig

22 Spring housing body (Second member)

22S Second abutment face

22a, 22b Spring housing body end face

23 Roller

24 Bottom part

26 Sidewall part

26S Sidewall face

28 Space

29, 34 Bolt hole

30 Cover body (First member)

30S First abutment face

32 Projection

36 Jig taper portion

38 Bolt

40 Hammer

1. A blade root spring insertion jig for inserting a blade root spring into a gap between a bottom face of a blade groove formed in a rotor disk of a rotary machine and a blade root part of a blade which engages with the blade groove, the blade root spring having a blade contact face contacting the blade root part and a rotor contact face contacting the bottom face of the blade groove, the blade root spring insertion jig comprising:
a first abutment face contacting a blade contact face side of the blade root spring; and
a second abutment face opposing the first abutment face and contacting a rotor contact face side of the blade root spring,
wherein the first abutment face and the second abutment face are configured to press the blade root spring so that the blade root spring is compressed and a height of the blade root spring becomes smaller than a natural height of the blade root spring.

2. The blade root spring insertion jig according to claim 1, further comprising:
a first member comprising the first abutment face;
a second member comprising the second abutment face; and
a clearance adjustment mechanism for changing a distance between the first member and the second member to adjust a clearance between the first abutment face and the second abutment face.

3. The blade root spring insertion jig according to claim 2,
wherein a projection is formed on the first member to contact the blade contact face.

4. The blade root spring insertion jig according to claim 1,
wherein at least one of the first abutment face or the second abutment face has a taper shape such that a distance between the first abutment face and the second abutment face gradually becomes smaller along an insertion direction of the blade root spring.

5. The blade root spring insertion jig according to claim 1, further comprising:
a pair of sidewall faces which forms with the first abutment face and the second abutment face a space for housing the blade root spring,
wherein the pair of sidewall faces is inclined relative to a jig end face of the blade root spring insertion jig so that the pair of sidewall faces is parallel to the blade groove when the jig end face is abutted to a disk end face of the rotor disk in a periphery of the blade groove.

6. The blade root spring insertion jig according to claim 1,
wherein a clearance between the first abutment face and the second abutment face is set so that the height of the blade root spring compressed by the first abutment face and the second abutment face is greater than the gap between the bottom face of the blade groove and the blade root part.

7. The blade root spring insertion jig according to claim 2, further comprising
a roller provided in an abutment part of at least one of the first member or the second member, the abutment part being configured to contact the blade root spring.

8. A blade root spring insertion method for inserting a blade root spring into a gap between a bottom face of a blade groove formed in a rotor disk of a rotary machine and a blade root part of a blade which engages with the blade groove, the method comprising steps of:
compressing the blade root spring so that a height of the blade root spring becomes smaller than a natural height of the blade root spring; and
inserting the blade root spring in the blade groove in such a state that the blade root spring is compressed.
